(19) United States
(12) Patent Application Publication
(10) Pub. No.: US 2005/0245650 A1
(43) Pub. Date: Nov. 3, 2005

(54) Method for preparing an emulsion by diluting an emulsifiable concentrate comprising an amphiphilic copolymer

(76) Inventors: Sophie Deroo, L'Hay Les Roses (FR); Mikel Morvan, Princeton, NJ (US); Mathias Destarac, Paris (FR)

Correspondence Address: Jean Louis Seugnet;Rhodia Inc, Intellectual Property Department, 259 Prospect Plains Road CN 7500, Cranbury, NJ, 08512-7500, US

(21) Appl. No.: 10/511,701

(22) PCT Filed: Apr. 11, 2003
(86) PCT No.: PCT/FR03/01153

§ 371 Date: Apr. 18, 2005

(30) Foreign Application Priority Data
Apr. 18, 2002 (FR) 02/04860

(51) Int. Cl. C08K 5/42

(52) U.S. Cl. 524/157

(57) ABSTRACT

The invention concerns a method for preparing a direct emulsion, which consists in diluting in an aqueous phase a clear emulsifiable concentrate comprising an oil phase, optionally water, and amphiphilic compounds consisting of at least one surfactant, at least one copolymer having at least one hydrophilic segment and at least one hydrophobic segment, optionally at least one co-surfactant and optionally at least one neutralizing agent; the total content in amphiphilic compounds representing 1 to 40 wt. % of the emulsifiable concentrate; the copolymer content representing at least 0,1 to 25 wt. % of said amphiphilic compounds; more than 75 wt. % of the emulsion droplets have an average size not more than 1 m; the average size of the droplets of an emulsion obtained by diluting a emulsifiable concentrate free of said copolymer; the total concentration in amphiphilic compounds being the same in both cases.

A subject matter of the present invention is a process for the preparation of an emulsion by dilution of an emulsifiable concentrate comprising a copolymer comprising at least one hydrophilic segment and at least one hydrophobic segment.

The use of emulsions has very greatly expanded, whether in the fields of plant protection, the treatment of metal, the papermaking industry, paints, the treatment of textile fibers (in particular textile sizing), cosmetics, and the like.

Emulsions comprise two phases, one of which is dispersed in the other, the combination being kept stable by virtue of the use of appropriate surfactants.

One of the difficulties encountered with emulsions is that they are systems which are not in thermodynamic equilibrium, unlike macroemulsions, which are in thermodynamic equilibrium. Thus, emulsions, after a more or less lengthy time, will result in separation of the two phases.

Furthermore, in order to achieve a satisfactory degree of stability, emulsions comprise not insignificant contents of surfactants. In point of fact, the presence of surfactants in these amounts can have negative consequences which limit the use of these emulsions or which render their use more complex. This is because the use of high amounts of surfactants in emulsions results in the appearance of a foam phenomenon which is undesirable in the majority of cases. It is therefore very often necessary to incorporate an antifoaming agent in the formulation.

Another difficulty with the use of emulsions lies in the fact that, in some applications, active materials are used which are reactive with respect to the water. Two possibilities can then be envisaged, either to prevent the reaction of the active material with the water by masking the hydrolysis-sensitive functional group and to provide, when the emulsion is applied, for example, for the addition of a compound which deblocks the functional group and allows it to react with a compound present in the formulation or introduced for this purpose, for example possessing hydroxyl functional groups. It is clear that this method is far from being applicable to all the substances concerned.

Thus, it is necessary to improve the properties of emulsions and/or to find alternatives thereto which would be more stable on storage than emulsions, which would facilitate the use of reactive compounds without having to mask them.

Emulsifiable concentrates represent a highly advantageous alternative of several accounts.

This is because they are advantageous in the sense that, being devoid of water, they introduce a solution to the problem of stability of emulsions and to that of the use of hydrolyzable compounds. Furthermore, they are self-emulsifiable formulations, which means that, when they are brought into contact with the required amount of aqueous phase, they give a direct emulsion. The difficulty is that, to succeed in obtaining an emulsion for which the characteristics of size of the droplets, for example, are appropriate, it is necessary to employ relatively high contents of surfactants. Consequently, it is not unusual for the emulsions resulting from emulsifiable concentrates to comprise, for their part also, high contents of surfactants.

An aim of the present invention is thus to overcome the disadvantages mentioned above.

Thus, a subject matter of the present invention is a process for the preparation of a direct emulsion, in which process the dilution is carried out, in an aqueous phase, of a clear emulsifiable concentrate comprising an oil phase, optionally water, and amphiphilic compounds composed of at least one surfactant, at least one copolymer having at least one hydrophilic segment and at least one hydrophobic segment, with the exclusion of copolymers comprising only segments obtained from ethylene oxide and from propylene oxide, optionally at least one cosurfactant and optionally at least one neutralizing agent;
the total content of amphiphilic compounds representing 1 to 40% by weight of the emulsifiable concentrate;
the content of copolymer representing 0.1 to 25% by weight of said amphiphilic compounds;
more than 75% by volume of the droplets of the emulsion having a mean size of less than or equal to 1 μm;
the mean size of the droplets of an emulsion obtained by dilution of said concentrate being less than that of an emulsion obtained by dilution of an emulsifiable concentrate devoid of said copolymer, the total concentration of amphiphilic compounds being the same in both cases.

Another subject matter of the invention is composed of a clear emulsifiable concentrate comprising an oil phase, optionally water, and amphiphilic compounds composed of at least one surfactant, at least one copolymer having at least one hydrophilic segment and at least one hydrophobic segment, with the exclusion of copolymers comprising only segments obtained from ethylene oxide and from propylene oxide, optionally at least one cosurfactant and optionally at least one neutralizing agent;
the total content of amphiphilic compounds representing 1 to 40% by weight of the emulsifiable concentrate;
the content of copolymer representing 0.1 to 25% by weight of said amphiphilic compounds.

A subject matter of the present invention is thus emulsifiable concentrates which, while having lower contents of surfactants, make it possible to obtain, by dilution, emulsions for which the characteristics of size of the droplets are of the same order of magnitude as those achieved on diluting emulsifiable concentrates comprising the usual higher contents of surfactants.

Thus, the process according to the invention makes it possible, by virtue of the use of the abovementioned amphiphilic copolymer, to substantially lower, indeed even by more than 10 points in certain embodiments, the content of surfactant necessary in order to obtain emulsion sizes, after dilution of the concentrate, which are as fine as those obtained with conventional contents of surfactants, i.e. 10 points higher.

Consequently, the process according to the invention makes it possible to reduce the disadvantage related to the appearance of foam during the dilution of the emulsifiable concentrate.

Furthermore, the invention provides greater stability, over time and/or with regard to temperature, of the emulsion obtained by dilution of the emulsifiable concentrate. The term “stability over time” is understood to mean the period of time during which no phenomenon of coalescence, of creaming or of phase separation is observed at a given temperature. The term “stability with regard to temperature” is understood to mean the temperature below which these phenomena are not observed, at a given period of time. It is thus possible to obtain increased stability on using as much or less surfactant and/or equal stability on using less surfactant. It is noted that the stability required often depends on the field of use of the emulsifiable compound. In the field of plant protection formulations, for the formulations prepared directly in agricultural use (tank mix), a stability of a few hours, at temperatures which can reach approximately 40° C., proves to be useful.

The process according to the invention also makes it possible to be able to have available formulations comprising hydrolysis-sensitive compounds without having to prepare beforehand derivatives of these compounds for which the functional group reactive with regard to water will have been masked. This is in particular the case for compositions intended, for example, for the preparation of paint formulations. In addition to the advantage of not having to employ a system for masking and releasing the reactive functional group, the fact that emulsions are obtained with less surfactant exhibits the advantage of limiting the phenomena of migration of surfactants often observed in films, in particular paint films.

The fact that there is less surfactant in the emulsions obtained from the emulsifiable concentrates introduces an additional advantage with regard to the recycling of such emulsions.

However, other characteristics and advantages of the present invention will become more clearly apparent on reading the description and examples which will follow.

First of all, the term “clear” denotes a fluid having a transmission of 100%, the measurement being carried out at 20° C. using a UV-visible spectrometer which measures the intensity transmitted at the given wavelength (λ=500 nm).

Furthermore, the mean size of the droplets of the emulsion obtained from the emulsifiable concentrate corresponds to the median diameter by volume (d₅₀), that is to say to the droplet diameter equal to 50% of the cumulative distribution. The size of the droplets is measured using a particle sizer of Horiba type. These particle size measurements are carried out by adding the emulsifiable concentrate to water at 20° C. and at the desired concentration, the addition operation being carried out with stirring for 5 minutes at 200 rev/min using an anchor paddle stirrer.

As indicated above, the emulsifiable concentrate comprises an oil and optionally water.

In accordance with an embodiment of the invention, the emulsifiable concentrate is provided in the form of a single-phase composition.

The oil is chosen more particularly from the compounds having a solubility in water at 20° C. not exceeding 10% by weight.

In addition, the oil is more particularly in a form which is liquid at the temperature of use of the emulsion obtained from the emulsifiable concentrate. Generally, the temperature range for use is close to ambient temperature, i.e. approximately between 15 and 40° C., although higher temperatures are not excluded, the latter, however, preferably remaining below 100° C. It should be noted that the oil can consist of a mixture of several compounds, one of which may not be liquid at the temperature of use, provided that the combination is liquid within this temperature range.

Thus, mention may be made, as organic oils of animal origin, inter alia, of sperm oil, whale oil, seal oil, sardine oil, herring oil, shark oil or cod liver oil. Beeswax, pig fat or sheep fat may likewise be suitable. Mention may be made, as examples of organic oils of vegetable origin, inter alia, of rapeseed oil, sunflower oil, peanut oil, olive oil, walnut oil, corn oil, soybean oil, linseed oil, hemp oil, grape seed oil, coconut oil, palm oil, cottonseed oil, babassu oil, jojoba oil, sesame oil, castor oil or carnauba wax.

Mention may be made, as regards mineral oils, inter alia, of the oils resulting from petroleum fractions, such as, for example, naphthenic oils, paraffinic oils (liquid petrolatum), hexadecane and paraffin waxes.

The products resulting from the alcoholysis of the abovementioned oils can also be used.

It would not be departing from the scope of the present invention to employ at least one saturated or unsaturated fatty acid, at least one saturated or unsaturated fatty acid ester, at least one saturated or unsaturated fatty alcohol, or their mixtures.

More particularly, said acids, esters or alcohols comprise at least one hydrocarbonaceous radical exhibiting from 10 to 40 carbon atoms, more particularly 18 to 40 carbon atoms, and can comprise one or more conjugated or nonconjugated carbon-carbon double bonds. Furthermore, the acids, esters or alcohols can comprise one or more hydroxyl groups.

Mention may be made, as examples of saturated fatty acids, of palmitic acid, stearic acid, isostearic acid or behenic acid.

Mention may be made, as examples of unsaturated fatty acids, of myristoleic acid, palmitoleic acid, oleic acid, erucic acid, linoleic acid, linolenic acid, arachidonic acid, ricinoleic acid, and their mixtures.

Mention may be made, as fatty acid esters, of the esters of the acids mentioned above for which the part deriving from the alcohol comprises 1 to 6 carbon atoms, such as the methyl, ethyl, propyl or isopropyl esters, and the like.

Mention may be made, as examples of alcohols, of those corresponding to the abovementioned acids.

It can likewise be envisaged to employ the esters of the abovementioned acids and of polyols, such as, for example, of glycerol, of polyglycerol (such as, for example, polyglycerol polyricinoleate), of glycol, of propylene glycol, of ethylene glycol, of polyethylene glycol, of polypropylene glycol, of neopentyl glycol (such as, for example, neopentyl glycol hydroxyl-pivalate), of pentaerythritol, of dipentaerythritol, of trimethylolpropane, of sorbitol, of mannitol, of xylitol or of meso-erythritol.

The oil can likewise be chosen from alkyd resins (such as, for example, the Coporob 3115 DE resins sold by Novance), epoxy resins, masked (poly)isocyanates or, advantageously, nonmasked (poly)isocyanates, provided that the emulsifiable concentrate is devoid of water.

The oil can also be chosen from essential oils or mono-, di- or triglycerides.

Silicones can likewise be used in the emulsifiable concentrates according to the invention. Silicones composed in all or part of units of formulae:
R′₃₋ₐRₐSiO_{1/2} (M unit) and/or R₂SiO (D unit)
formulae where:
a is an integer from 0 to 3;
the R radicals are identical or different and represent:
   a saturated or unsaturated aliphatic hydrocarbonaceous group comprising from 1 to 10 carbon atoms;
an aromatic hydrocarbonaceous group comprising from 6 to 13 carbon atoms;
a polar organic group bonded to the silicon via an Si—C or Si—O—C bond;
the R′ radicals are identical or different and represent:
   a saturated or unsaturated aliphatic hydrocarbonaceous group comprising from 1 to 10 carbon atoms;
   an aromatic hydrocarbonaceous group comprising from 6 to 13 carbon atoms;
   an —OH functional group;
   an amino- or amidofunctional group comprising from 1 to 6 carbon atoms, bonded to the silicon via an Si—N bond;
      may be suitable.

Preferably, at least 80% of the R radicals represent a methyl group.

These silicones can optionally comprise, preferably less than 5 mol %, units of formulae T and/or Q:
RSiO_{3/2} (T unit) and/or SiO₂ (Q unit)
in which formula R has the definition given above.

Mention may be made, as examples of aliphatic or aromatic hydrocarbonaceous radicals R, of the following groups:
alkyl, preferably optionally halogenated C₁-C₁₀ alkyl, such as methyl, ethyl, octyl or trifluoropropyl;
alkoxyalkylene, more particularly C₂-C₁₀ alkoxy-alkylene, preferably C₂-C₆ alkoxyalkylene, such as —CH₂—CH₂—O—CH₃;
alkenyl, preferably C₂-C₁₀ alkenyl, such as vinyl, allyl, hexenyl, decenyl or decadienyl;
alkenyloxyalkylene, such as —(CH₂)₃—O—CH₂—CH═CH₂, or alkenyloxyalkoxyalkyl, such as —(CH₂)₃—OCH₂—CH₂—O—CH═CH₂, in which the alkyl parts are preferably C₁-C₁₀ alkyl parts and the alkenyl parts are preferably C₂-C₁₀ alkenyl parts;
aryl, preferably C₆-C₁₃ aryl, such as phenyl.

Mention may be made, as examples of polar organic groups R, of the following groups:
hydroxyfunctional, such as alkyl groups substituted by one or more hydroxyl or di(hydroxyalkyl)amino groups and optionally interrupted by one or more divalent hydroxyalkylamino groups. The term “alkyl” is understood to mean a hydrocarbonaceous chain, preferably a C₁-C₁₀ hydrocarbonaceous chain, better still a C₁-C₆ hydrocarbonaceous chain; examples of these groups are —(CH₂)₃—OH, —(CH₂)₄N (CH₂CH₂OH)₂ or —(CH₂)₃—N (CH₂CH₂OH)—CH₂—CH₂—N(CH₂CH₂OH)₂;
aminofunctional, such as alkyl substituted by one or more amino or aminoalkylamino groups where alkyl is as defined above; examples thereof are —(CH₂)₃—NH₂ or (CH₂)₃—NH—(CH₂)₂NH₂;
amidofunctional, such as alkyl substituted by one or more acylamino groups and optionally interrupted by one or more divalent alkyl-CO—N<groups where alkyl is as defined above and acyl represents alkylcarbonyl; an example is the —(CH₂)₃—N(COCH₃)—(CH₂)₂NH(COCH₃) group;
carboxyfunctional, such as carboxyalkyl optionally interrupted by one or more oxygen or sulfur atoms, where alkyl is as defined above; an example is the —CH₂—CH₂—S—CH₂—COOH group.

Mention may be made, as examples of R′ radicals, of the following groups:
alkyl, preferably optionally halogenated C₁-C₁₀ alkyl, such as methyl, ethyl, octyl or trifluoropropyl;
aryl, preferably C₆-C₁₃ aryl, such as phenyl;
aminofunctional, such as alkyl or aryl substituted by amino, alkyl preferably being C₁-C₆ alkyl and aryl denoting a, preferably C₆-C₁₃, cyclic aromatic hydrocarbonaceous group, such as phenyl; examples thereof are ethylamino or phenylamino;
amidofunctional, such as alkylcarbonylamino where alkyl is preferably C₁-C₆ alkyl; examples thereof are methylacetamido.

Mention may be made, as concrete examples of “D units”, of: (CH₃)₂SiO, CH₃(CH═CH₂)SiO, CH₃(C₆H₅)SiO, (C₆H₅)₂SiO or CH₃(CH₂—CH₂—CH₂OH)SiO.

Mention may be made, as concrete examples of “M units”, of: (CH₃)₃SiO_{1/2}, (CH₃)₂(OH)SiO_{1/2}, (CH₃)₂(CH═CH₂)SiO_{1/2}, (OCH₃)₃SiO_{1/2}, [O—C(CH₃)═CH₂]₃SiO_{1/2}, [ON═C(CH₃)]₃SiO_{1/2}, (NH—CH₃)₃SiO_{1/2} or (NH—CO—CH₃)₃SiO_{1/2}.

Mention may be made, as concrete examples of “T units”, of: CH₃SiO_{3/2} or (CH═CH₂)SiO_{3/2}.

When the silicones comprise reactive and/or polar radicals R (such as OH, vinyl, allyl, hexenyl, aminoalkyl, and the like), the latter generally do not represent more than 5% of the weight of the silicone and preferably do not represent more than 1% of the weight of the silicone.

Volatile oils, such as hexamethyldisiloxane, octamethyldisiloxane, decamethyltetrasiloxane, dodecamethylpentasiloxane, tetradecamethylhexasiloxane, hexadecamethylhexasiloxane, heptamethyl-3-[(trimethylsilyl)oxy]trisiloxane, hexamethyl-3,3-bis[(trimethylsilyl)oxy]trisiloxane; hexamethylcyclotrisiloxane, octamethylcyclotetrasiloxane, decamethylcyclopentasiloxane, dodecamethylcyclohexasiloxane or pentamethyl-[(trimethylsilyl)oxy]cyclotrisiloxane, can be used.

Use may likewise be made of nonvolatile silicones, such as polydimethylsiloxane and α,ω-bis(hydroxy)polydimethylsiloxane oils and gums and polydimethylsiloxane, polyphenylmethylsiloxane and α,ω-bis-(hydroxy)polydimethylsiloxane gums.

Preference is more particularly given to α,ω-bis-(trimethyl)polydimethylsiloxane oils and α,ω-bis-(hydroxy)polydimethylsiloxane oils and very particularly to silicones of polydimethylsiloxane (dimethicone) and diphenyl dimethicone type.

The oil can optionally comprise an active material, unless it is itself regarded as an active material.

The active material, if it is other than the oil, is provided in a form miscible with the oil or alternatively dissolved in an organic solvent miscible with the oil.

Furthermore, the active material is chosen from compounds having a solubility in water at 20° C. not exceeding 10% by weight.

Mention may be made, as examples of active materials in the field of cosmetics, of silicone oils belonging, for example, to the family of the dimethicones; lipophilic vitamins, such as vitamin A and its derivatives, in particular its esters, such as the acetate, palmitate or propionate, vitamin B₂, pantothenic acid, vitamin D and vitamin E.

In the field of agrochemistry, the plant-protection active materials can be chosen from the family of the α-cyanophenoxybenzyl carboxylates or of the α-cyanohalophenoxy carboxylates, the family of the N-methyl-carbonates comprising aromatic substituents, or active materials such as aldrin, azinphos-methyl, benfluralin, bifenthrin, chlorphoxim, chlorpyrifos, fluchloralin, fluroxypyr, dichlorvos, malathion, molinate, parathion, permethrin, profenofos, propiconazole, prothiofos, pyrifenox, butachlor, metolachlor, chlormephos, diazinon, fluazifop-P-butyl, heptopargil, mecarbam, propargite, prosulfocarb, bromophos-ethyl, carbo-phenothion, cyhalothrin.

Said active materials mentioned above can optionally be in a form dissolved in an appropriate solvent, for example xylene or Solvesso®.

Mention may be made, as possible active materials, of silicone or organic antifoaming agents used in numerous fields, such as that of detergency, for example.

It is likewise possible to use active materials such as those participating in the composition of lubricants for the working or deformation of materials. The active material is usually an oil, an oil derivative or alternatively a fatty acid ester.

The active material can also be chosen from organic solvents or mixtures of such solvents which are immiscible or not very miscible in water, such as, in particular, those employed for cleaning or stripping, such as aromatic petroleum fractions, terpene compounds, such as D-limonene or L-limonene, and solvents, such as Solvesso®. Aliphatic esters, such as methyl esters, of a mixture of acetic acid, succinic acid and glutaric acid (mixture of acids arising as a by-product from the synthesis of nylon), hydrocarbonaceous oils, such as liquid petrolatum, and chlorinated solvents are also suitable as solvents.

If an active material other than the oil is present, its content is usually less than or equal to 50% by weight of oil, preferably between 10 and 50% by weight of oil.

The total content of oil in the emulsifiable concentrate, including, if appropriate, the active material, advantageously represents from 60 to 95% by weight of the emulsifiable concentrate.

In the case where the emulsifiable concentrate comprises water, its content is such that the emulsifiable concentrate remains clear within the meaning indicated above. The content varies according to the various constituent components of the emulsifiable concentrate and can be easily determined by a person skilled in the art.

By way of illustration, the content of water in the emulsifiable concentrate, if it is present, is less than or equal to 10% by weight of the concentrate.

The emulsifiable concentrate furthermore comprises amphiphilic compounds composed of at least one surfactant, at least one copolymer having at least one hydrophilic segment and at least one hydrophobic segment, optionally at least one cosurfactant and optionally at least one neutralizing agent.

It is specified that the combination comprising the surfactant, optionally the cosurfactant and optionally the neutralizing agent is soluble in the oil at ambient temperature (approximately 20° C.).

Preferably, the surfactant or surfactants are chosen from surfactants which are soluble in the oil at the concentrations employed in the invention.

Advantageously, the surfactants are chosen from noninic or anionic surfactants.

According to a first alternative form, the surfactant or surfactants are chosen from nonionic surfactants.

By way of illustration, the following are suitable in particular, alone or as a mixture:
alkoxylated fatty alcohols, more particularly comprising from 6 to 22 carbon atoms;
alkoxylated mono-, di- and triglycerides;
alkoxylated fatty acids, more particularly comprising from 6 to 22 carbon atoms;
alkoxylated sorbitan esters (cyclized esters of sorbitol and of fatty acid comprising from 10 to 20 carbon atoms);
alkoxylated fatty amines, more particularly comprising from 6 to 22 carbon atoms;
alkoxylated alkylphenols, more particularly comprising one or two linear or branched alkyl groups having 4 to 12 carbon atoms;
alkylpolyglucosides;
polyoxyalkylenated surfactants, such as, for example, the compounds sold under the Pluronic or Poloxamer range by BASF;
alkoxylated mono- and dialkanolamides;
   alone or as mixtures.

According to a second alternative form, the surfactant or surfactants are chosen from anionic surfactants in the acid form or combined with a polyvalent counterion.

The polyvalent counterion is preferably an alkaline earth metal, such as magnesium or calcium, alone or combined.

With regard to the surfactants, the compounds listed in the nonexhaustive fashion below can be employed:
alkyl ester sulfonates, for example of formula R—CH(SO₃M)-CH₂COOR′, where R represents a C₈-C₂₀, preferably C₁₀-C₁₆, hydrocarbonaceous radical optionally carrying one or more unsaturations, R′ represents a C₁-C₆, preferably C₁-C₃, alkyl radical and M represents a hydrogen atom or an alkaline earth metal cation. Mention may very particularly be made of methyl ester sulfonates, the R radical of which is a C₁₄-C₁₆ radical;
alkyl ester sulfates, for example of formula R—CH(OSO₃M)-CH₂COOR′, where R represents a C₈-C₂₀, preferably C₁₀-C₁₆, hydrocarbonaceous radical optionally carrying one or more unsaturations, R′ represents a C₁-C₆, preferably C₁-C₃, alkyl radical and M represents a hydrogen atom or an alkaline earth metal cation;
alkylbenzenesulfonates, more particularly C₉-C₂₀ alkylbenzenesulfonates, primary or secondary alkylsulfonates, in particular C₈-C₂₂ alkylsulfonates, or alkylglycerolsulfonates;
alkyl sulfates, for example of formula ROSO₃M, where R represents a C₁₀-C₂₄, preferably C₁₂-C₂₀, alkyl or hydroxyalkyl radical and M represents a hydrogen atom or a cation with the same definition as above;
alkyl ether sulfates, for example of formula RO(AO)ₙSO₃M, where R represents a C₁₀-C₂₄, preferably C₁₂-C₂₀, alkyl or hydroxyalkyl radical, OA represents an ethoxyl and/or propoxyl group, M represents a hydrogen atom or a cation with the same definition as above and n varies generally from 1 to 4, such as, for example, the lauryl ether sulfate with n=2;
alkylamide sulfates, for example of formula RCONHR′OSO₃M, where R represents a C₂-C₂₂, preferably C₆-C₂₀, alkyl radical, R′ represents a C₂-C₃ alkyl radical and M represents a hydrogen atom or a cation with the same definition as above, and their polyalkoxylated (ethoxylated and/or propoxylated) derivatives;
salts of saturated or unsaturated fatty acids, for example such as those of C₈-C₂₄, preferably C₁₄-C₂₀, fatty acids, and of an alkaline earth metal cation, N-acyl-N-alkyltaurates, alkyl isethionates, alkylsuccinamates and alkyl sulfosuccinates, monoesters or diesters of sulfosuccinates, N-acylsarcosinates and polyethoxycarboxylates; and
phosphate mono- and diesters, for example of the following formula: (RO)ₓ—P(═O) (OM)ₓ, where R represents an optionally polyalkoxylated alkyl, alkylaryl, arylalkyl or aryl radical, x and x′ are equal to 1 or 2, provided that the sum of x and x′ is equal to 3, and M represents a hydrogen atom or an alkaline earth metal cation;
   alone or as mixtures.

The surfactant content in the emulsifiable concentrate is such that the total content of amphiphilic compounds is between 1 and 40% by weight of the emulsifiable concentrate.

The amphiphilic compounds present in the emulsifiable concentrate include copolymers having at least one hydrophilic segment and at least one hydrophobic segment, with the exclusion of polymers comprising only segments obtained from ethylene oxide and from propylene oxide.

The amphiphilic compound is chosen so that the combination of the amphiphilic compounds is soluble in the oil, if appropriate, in the presence of a small amount of water. Preferably, said amphiphilic compound is chosen from compounds which are soluble in the oil.

As regards more especially the hydrophobic segment of the copolymer, the latter can be obtained from one or more of the following monomers:
esters of linear, branched, cyclic or aromatic mono- or polycarboxylic acids comprising at least one ethylenic unsaturation and optionally carrying a hydroxyl group;
α,β-ethylenically unsaturated nitriles, vinyl ethers, vinyl esters, vinylaromatic monomers, vinyl halides or vinylidene halides,
linear or branched aromatic or nonaromatic hydrocarbonaceous monomers comprising at least one ethylenic unsaturation,
propylene oxide or butylene oxide,
   alone or as mixtures, and the macromonomers deriving from such monomers.

Mention may be made, as specific examples of hydrophobic monomers capable of participating in the preparation of the hydrophobic segment or segments of the segment-comprising amphiphilic copolymer, of:
esters of (meth)acrylic acid with an alcohol comprising 1 to 12 carbon atoms, such as methyl (meth)acrylate, ethyl (meth)acrylate, propyl (meth)acrylate, n-butyl (meth)acrylate, tert-butyl (meth)acrylate, isobutyl (meth)acrylate or 2-ethylhexyl acrylate;
vinyl acetate, vinyl Versatate®, vinyl propionate, vinyl chloride, vinylidene chloride, methyl vinyl ether or ethyl vinyl ether;
vinyl nitriles, including more particularly those having from 3 to 12 carbon atoms, such as, in particular, acrylonitrile and methacrylonitrile;
styrene, α-methylstyrene, vinyltoluene, butadiene, isoprene or chloroprene;
propylene oxide or butylene oxide,
   alone or as mixtures, and the macromonomers deriving from such monomers.

The preferred monomers are the esters of acrylic acid with linear or branched C₁-C₄ alcohols, such as methyl acrylate, ethyl acrylate, propyl acrylate and butyl acrylate, vinyl esters, such as vinyl acetate, styrene and α-methylstyrene.

As regards the hydrophilic segment of the amphiphilic copolymer, the latter can be obtained from one or more monomers exhibiting an anionic functional group or a functional group which can be converted to an anion.

It is specified that, under the pH conditions under which the copolymer is used, the functional groups of the anionic segment or segments of the copolymer are found in an at least partially ionized (dissociated) form. More particularly, at least 10 mol % of the functional groups of the segment or segments are in the ionized form. The determination of this value does not present a problem to a person skilled in the art; it depends in particular on the pKa of the ionizable functional groups of the units of the copolymer and on the number of these functional groups (i.e., on the number of moles of monomer carrying ionizable functional groups employed during the preparation of the copolymer).

More particularly comprising at least one carboxylic, sulfonic, sulfuric, phosphonic, phosphoric or sulfosuccinic functional group, their salts, and their corresponding macromonomers.

More specifically, the anionic monomer or monomers or the monomer or monomers which can be converted to an anion can be chosen from the following:
linear, branched, cyclic or aromatic mono- or polycarboxylic acids, the N-substituted derivatives of such acids, or monoesters of polycarboxylic acids comprising at least one ethylenic unsaturation;
linear, branched, cyclic or aromatic vinylcarboxylic acids;
amino acids comprising one or more ethylenic unsaturations;
   alone or as mixtures, their precursors, their sulfonic or phosphonic homologs or their salts, and the macromonomers deriving from such monomers or from their salts.

Mention may be made, as examples of anionic monomers/monomers which can be converted to an anion, without intending to be restricted thereto, of:
acrylic acid, methacrylic acid, fumaric acid, itaconic acid, citraconic acid, maleic acid, acrylamidoglycolic acid, 2-propene-1-sulfonic acid, methallylsulfonic acid, styrenesulfonic acid, α-acrylamidomethylpropanesulfonic acid, 2-sulfoethylene methacrylate, sulfopropyl acrylic acid, bis(sulfopropyl)acrylic acid, bis(sulfopropyl)methacrylic acid, sulfatoethylmethacrylic acid, the phosphate monoester of hydroxyethylmethacrylic acid, and the salts of alkali metals, such as sodium or potassium, or of ammonium;
vinylsulfonic acid, vinylbenzenesulfonic acid, vinylphosphonic acid, vinylidenephosphonic acid, vinylbenzoic acid, and the salts of alkali metals, such as sodium or potassium, or of ammonium;
N-(methacryloyl)alanine or N-(acryloyl)hydroxy glycine;
   alone or as mixtures, and the macromonomers deriving from such monomers.

It will not be departing from the scope of the present invention to employ precursor monomers of those which have just been mentioned. In other words, these monomers exhibit units which, once incorporated in the polymer chain, can be converted, in particular by a chemical treatment, such as hydrolysis, to restore the abovementioned anionic entities/entities which can be converted to an anion. For example, the completely or partially esterified monomers of the abovementioned monomers can be employed in order, subsequently, to be completely or partially hydrolyzed.

According to another possibility, the hydrophilic segment or segments can be obtained from one or more monomers exhibiting a cationic functional group or a functional group which can be converted to a cation.

The following can be employed as such:
aminoalkyl (meth)acrylates or aminoalkyl(meth)acrylamides;
monomers comprising at least one secondary, tertiary or quaternary amine functional group or a heterocyclic group comprising a nitrogen atom, vinylamine or ethyleneimine;
diallyldialkylammonium salts;
   alone or as mixtures, or the corresponding salts, and the macromonomers deriving from such monomers.

If they are provided in the form of salts, the latter are preferably chosen so that the counterion is a halide, such as, for example, a chloride, a sulfate, a hydrogensulfate, an alkyl sulfate, a phosphate, a citrate, a formate or an acetate.

Furthermore, the ammonium functional group comprises at least one alkyl radical or at least one aryl radical optionally carrying one or more alkyl radicals having from 1 to 6 carbon atoms, preferably methyl or ethyl.

Examples of suitable cationic monomers include the following monomers:
dimethylaminoethyl (meth)acrylate, dimethylaminopropyl (meth)acrylate, di(tert-butyl)-aminoethyl (meth)acrylate, dimethylaminomethyl-(meth)acrylamide or dimethylaminopropyl(meth)acrylamide;
ethyleneimine, vinylamine, 2-vinylpyridine or 4-vinylpyridine;
trimethylammonium ethyl (meth)acrylate chloride, trimethylammonium ethyl acrylate methyl sulfate, benzyldimethylammonium ethyl (meth)acrylate chloride, 4-benzoylbenzyl-dimethylammonium ethyl acrylate chloride, trimethylammonium ethyl(meth)acrylamide chloride or vinylbenzyltrimethylammonium chloride;
diallyldimethylammonium chloride;
   alone or as mixtures, or their corresponding salts.

Finally, the hydrophilic segment or segments of the amphiphilic copolymer can be obtained from nonionic hydrophilic monomer(s).

It is pointed out that the amphiphilic copolymers can be blocked polymers and can comprise at least two blocks, one being hydrophilic and the other hydrophobic. It should be remembered that such copolymers are linear. Advantageously, the copolymers employed are diblock or triblock copolymers.

It can likewise be envisaged employing a comb copolymer, one of the segments of which is hydrophilic and the other hydrophobic.

In accordance with this embodiment, use is made, without distinction, of a copolymer having a hydrophilic backbone and pendant hydrophobic groups, or vice versa.

Mention may be made, as examples of nonionic hydrophilic monomers, of ethylene oxide; the amides of linear, branched, cyclic or aromatic mono- or polycarboxylic acids comprising at least one ethylenic unsaturation, or derivatives; hydrophilic esters deriving from (meth)acrylic acid; vinyl esters which make it possible to obtain poly(vinyl alcohol) blocks after hydrolysis; vinylpyrrolidone; monomers of the type of the sugars, such as (meth)acrylates of oligosaccharides or of oligoholosides, and the macromonomers deriving from these monomers.

Mention may very particularly be made, as regards the preferred nonionic hydrophilic monomers, of (meth)acrylamide, N-methylol(meth)acrylamide, 2-hydroxyethyl (meth)acrylate, and the vinyl esters which make it possible to obtain poly(vinyl alcohol) blocks after hydrolysis, such as vinyl acetate, vinyl Versatate® or vinyl propionate.

Such monomers can be used alone or as mixtures, and in the form of macromonomers.

It is specified that the hydrophobic segment of the copolymer can comprise one or more hydrophilic units and likewise the hydrophilic segment can comprise one or more hydrophobic units.

It is specified that, in the event of a segment of the copolymer being composed of several monomers, the distribution of the latter within the segment can be random, block or according to a concentration ingredient.

The copolymers which can be used in the context of the invention can be prepared by carrying out polymerizations by the anionic route, by the cationic route or by the “living” or “controlled” radical route. It is likewise possible to carry out, depending on the monomers employed, a group transfer polymerization or else a ring-opening polymerization (case in particular of polymerization starting from an N-carboxyanhydride ring) or alternatively a polymerization involving a transesterification of end groups.

Preferably, the polymers are obtained by carrying out at least one living radical polymerization stage.

Reference may in particular be made, as examples of “living” or “controlled” polymerization processes, to:
radical polymerization controlled by xanthates, according to the teaching of application WO 98/58974,
radical polymerization controlled by dithioesters, according to the teaching of application No. WO 98/01478,
polymerization using nitroxide precursors, according to the teaching of application WO 99/03894,
radical polymerization controlled by dithiocarbamates, according to the teaching of application WO 99/31144,
atom transfer radical polymerization (ATRP), according to the teaching of application WO 96/30421.

In the case of polymers carrying grafts (comb polymers), they can in particular be obtained by various methods, such as, for example, copolymerization of a monomer with a macromonomer. More particularly, this method employs, in a first step, the grafting, at the end of the segment, of a functional group which can be polymerized by the radical route. This grafting can be carried out by conventional methods of organic chemistry. Then, in a second step, the macromonomer thus obtained is polymerized with the chosen monomer to form the backbone and a “comb” polymer is obtained.

It is likewise possible to obtain comb polymers by polymerization of a monomer, followed by grafting to the backbone thus obtained. The grafting of the side polymer segments to a backbone polymer segment can be carried out according to conventional techniques familiar to a person skilled in the art (European Polymer Journal, 4, 343 (1968), for example). Mention may in particular be made, among these conventional techniques, of “direct grafting” techniques.

In the more specific context of segment copolymers comprising repeat units exhibiting one or more silicon atoms, reference may be made to the description of application WO 02/08307, published on 01/31/02, detailing a process for producing such copolymers.

In addition, in this final category of copolymers, it would not be departing from the scope of the invention to use compounds of the type of polyether polyalkyl grafted polydimethylsiloxane block copolymers (Tegopren®, sold by Goldschmidt).

The copolymers participating in the composition of the emulsifiable concentrate more especially exhibit a weight-average molar mass of at most 50 000 g/mol, preferably of at most 20 000 g/mol.

Furthermore, the weight-average molar mass of the copolymer is advantageously at least 2500 g/mol, preferably at least 5000 g/mol.

According to one characteristic of the invention, the copolymer content is such that, when this copolymer is added to a mixture comprising oil, the surfactant or surfactants, optionally the cosurfactant and optionally the neutralizing agent, a clear solution within the meaning indicated above is present, optionally with the addition of water, in the case where the oil and the active ingredient which it optionally comprises are not sensitive to hydrolysis.

Generally, the content of amphiphilic copolymer represents from 0.1 to 25% by weight of said amphiphilic compounds as defined above.

In addition, the proportion by weight of copolymer with respect to the surfactant is preferably between 0.5 and 10% by weight.

The emulsifiable concentrate employed in the process according to the invention can optionally comprise at least one cosurfactant.

Preferably, and if it is employed, a cosurfactant or a mixture of cosurfactants which are soluble in the oil is chosen.

More particularly, the cosurfactant is chosen from primary alcohols comprising at least one saturated or unsaturated and linear or branched aliphatic radical comprising from 4 to 22 carbon atoms or at least one aromatic radical, preferably comprising 6 carbon atoms, optionally carrying one or more alkyl substituents comprising 1 to 10 carbon atoms.

Among the alcohols capable of participating in the composition of the emulsifiable concentrates, isopropanol, ethylhexanol, dodecanol, hexadecanol and benzyl alcohol, alone or as mixtures, are suitable in particular.

If a cosurfactant is present, the cosurfactant/surfactant proportion by weight is preferably between 0 (not included) and 50% by weight, preferably between 5 and 40% by weight.

The emulsifiable concentrate can also optionally comprise at least one neutralizing agent.

Preferably, if it is present, use is made of a neutralizing agent which is soluble in the emulsifiable concentrate at between 15 and 40° C. or of a compound which, once heated beyond its melting point in the presence of oil and then cooled, remains soluble in the oil.

Advantageously, the neutralizing agent is chosen from compounds which are soluble in the oil phase and which carry at least one amine or carboxylic functional group.

For example, amines comprising one to three identical or different radicals comprising 1 to 10 carbon atoms, optionally carrying a hydroxyl radical, are suitable for this purpose. Mention may in particular be made, as examples of such amines, of ethylenediamine, triethylamine, dimethylbutylamine, dimethylisopropylamine, dimethylcyclohexylamine, tripropylamine, monoethanolamine, diethanolamine, aminoethylethanolamine or aminomethylpropanolamine can be used as neutralizing agent.

As regards the compounds having at least one carboxyl functional group, mention may be made of acetic acid, and the like.

This alternative form is advantageously employed when the surfactant comprises a compound which can be ionized under the pH conditions of the final emulsion.

If it is present, the neutralizing agent is used in an amount such that the neutralizing agent/surfactant proportion by weight is between 0 (not included) and 50% by weight, preferably between 5 and 40% by weight.

It is specified that the emulsifiable concentrate can comprise a cosurfactant and/or a neutralizing agent. Preferably, the emulsifiable concentrate comprises either a cosurfactant or a neutralizing agent.

Finally, according to one characteristic of the invention, the total content of amphiphilic compounds in the emulsifiable concentrate represents from 1 to 40% by weight of the emulsifiable concentrate. Preferably, the total content of amphiphilic compounds is between 5 and 30% by weight of the emulsifiable concentrate.

The emulsifiable concentrate is obtained by simple mixing of the various constituent components which have just been described in detail.

The temperature at which this mixing is carried out is generally such that the combination of the compounds is found in the liquid form. Advantageously, this temperature is above the melting point of each of the compounds.

As specified above, the emulsion is obtained by diluting the emulsifiable concentrate in an aqueous phase. This emulsion is a direct emulsion, that is to say an emulsion for which the continuous phase is an aqueous phase.

It is not ruled out that the aqueous phase with which the emulsifiable concentrate is diluted be, in itself, a formulation which can be used in a specific field. In this case, said aqueous phase comprises the additives conventional for the field of use.

According to one characteristic of the invention, the dilution of the emulsifiable concentrate results in the production of an emulsion for which at least 75% by volume of the droplets exhibit a mean size (d₅₀) of less than or equal to 1 μm.

It is to be noted that, according to one characteristic of the invention, the mean size of the droplets of the emulsion which is thus obtained is less than that of an emulsion obtained by dilution of an emulsifiable concentrate devoid of the copolymer described in detail previously, the total concentration of amphiphilic compounds being the same in both cases.

The mean size of the droplets of the emulsion which is obtained in accordance with the process according to the invention is therefore less than or equal to 1 μm, and more particularly between 0.2 and 1 μm.

The emulsifiable concentrate is preferably diluted by adding the emulsifiable concentrate to the aqueous phase.

The content of emulsifiable concentrate in the final formulation is highly variable according to the field of use of the concentrate. Purely by way of illustration, the content of emulsifiable concentrate represents 0.1 to 40% by weight of the final aqueous formulation, preferably 0.1 to 30% by weight of the final aqueous formulation.

The dilution operation conventionally takes place with gentle stirring, in particular using an anchor paddle stirrer.

The emulsion thus obtained can be used in numerous fields according to the nature of the oil, if appropriate of the active principle present, participating in the composition of the emulsifiable concentrate.

For example, the emulsifiable concentrate can be used in the field of phyto-protection formulations. In this case, the emulsion is prepared by the user before it is applied to the plants or fields to be treated.

The emulsions can likewise be used in the field of cosmetics.

The emulsions can likewise be used in the field of paints, varnishes and adhesives.

They can be used in the field of silicone or organic antifoaming agents.

They can also be used in processes for the transformation and deformation of metals and in particular as cutting fluid.

The emulsions obtained according to the invention can also be employed in the field of the papermaking industry, where emulsions with a relatively fine size are desired.

Concrete but nonlimiting examples of the invention will now be presented.

### EXAMPLES

### Example 1

### Synthesis of the p(BuA)₁₀₀₀-b-p(AA)₄₀₀₀ Diblock Copolymer P1

A) Stage 1: Synthesis of the p(BuA)₁₀₀₀ Monoblock

Composition of the reaction mixture:

| | |
|---|---|
| Ethanol | 23.00 g |
| Butyl acrylate (BuA) | 8.00 g |
| S-ethylpropionyl O-ethyl | 1.664 g |
| dithiocarbonate | |
| AIBN (azobisisobutyronitrile) | 0.263 g |

The ethanol, the butyl acrylate, the azobisisobutyro-nitrile (AIBN) and the S-ethylpropionyl O-ethyl dithiocarbonate are introduced into a 100 ml round-bottomed flask equipped with a reflux condenser and a magnetic stirrer.

The reaction medium is brought to 70° C. and is maintained at this temperature for 3 hours.

Samples of polymers are regularly withdrawn for monitoring the conversion.

The solids content is 30.2% at the end of the reaction.

B) Stage 2: Synthesis of the p(BuA)₁₀₀₀-b-p(AA)₄₀₀₀ Diblock

Composition of the reaction mixture:

| | |
|---|---|
| Ethanol | 93.00 g |
| Acrylic acid (AA) | 32.00 g |
| AIBN (azobisisobutyronitrile) | 0.263 g |

The above ingredients are charged to a dry receptacle under a dry nitrogen atmosphere for 20 minutes and are then transferred into the polymerization reactor, comprising the polymer resulting from the preceding stage, using a double-tip syringe.

At the end of the transfer, the reaction mixture is subsequently heated at 60° C. and is maintained at this temperature for 20 hours.

Samples of polymers are withdrawn from time to time to monitor the conversion. The dry matter content is 30% at the end of the reaction.

The reaction mixture is allowed to cool and the solvents are removed using a rotary evaporator.

The solids content is 30% at the end of the reaction.

The number-average molar mass of the copolymer is 5000 g/mol (theoretical value).

### Example 2

### Synthesis of a p(BuA)₃₀₀₀-b-p(VP)₆₀₀₀ Diblock Copolymer P2

A) Stage 1: Synthesis of the p(BuA)₃₀₀₀ Monoblock

Composition of the reaction mixture:

| | |
|---|---|
| Ethanol | 6.48 g |
| Butyl acrylate (BuA) | 4.00 g |
| AIBN (azobisisobutyronitrile) | 0.44 g |
| O-ethyl S-(1-methoxycarbonyl)ethyl | 0.278 g |
| xanthate | |

The abovementioned ingredients are introduced into a 100 ml round-bottomed flask equipped with a reflux condenser and a magnetic stirrer.

The reaction medium is brought to 70° C. and is maintained at this temperature for 3 hours.

A sample is then withdrawn and analyzed by steric exclusion chromatography and the number-average molar mass is of the order of 3100 g/mol.

B) Stage 2: Synthesis of the p(BuA)₃₀₀₀-b-p(VP)₆₀₀₀ Diblock

Composition of the reaction mixture:

| | | |
|---|---|---|
| Ethanol | 24.2 | g |
| N-Vinylpyrrolidone (VP) | 16 | g |
| AIBN | 0.131 | mg |

The reaction medium described in the first part of the example is maintained at a temperature of 70° C.

The ethanol, the N-vinylpyrrolidone and the AIBN are introduced.

The reaction is maintained for 6 hours from the time when the reactants are introduced.

At the end of the reaction, the ethanol is evaporated under vacuum.

The resulting diblock copolymer is subsequently dissolved in water.

A clear solution of copolymer is then obtained.

### Example 3

### Preparation of an Emulsifiable Concentrate Comprising P1

Composition of the emulsifiable concentrate:

| | |
|---|---|
| Hexadecane | 81.8% |
| Synperonic ® L7 | 11.4% |
| Dodecanol | 2.3% |
| P1 (dry weight) | 0.7% |
| Water | q.s. for 100% |

The emulsifiable concentrate is prepared by mixing, in a flask with stirring, the required amounts of hexadecane (Aldrich), Synperonic® L7 (ICI) and dodecanol (Prolabo), which are heated beforehand to 50° C., and the polymer P1.

The copolymer P1 is introduced from a 16% aqueous solution at neutral pH.

Emulsification is carried out by rapidly introducing the emulsifiable concentrate into purified water with gentle mechanical stirring with an anchor paddle stirrer at 200 revolutions/min and by stirring for 5 minutes.

The water content of the emulsion is 90%.

The size distribution of the oil droplets is determined by laser diffraction (Horiba LA-910).

The emulsion exhibits the following characteristics:
d₅₀=0.51 μm
84% by volume of the droplets exhibit a size of less than 1 μm

### Example 4, Comparative

### Preparation of an Emulsifiable Concentrate Devoid of Copolymer

Composition of the emulsifiable concentrate:

| | |
|---|---|
| Hexadecane | 85% |
| Synperonic ® L7 | 12.5% |
| Dodecanol | 2.5% |

The amphiphilic product/oil ratio is the same as in example 3.

The emulsion prepared according to the protocol described in example 3 in this case exhibits the following characteristics:
d₅₀=24 μm
5% by volume of the droplets exhibit a size of less than 1 μm.

### Example 5

### Preparation of an Emulsifiable Concentrate Comprising P2

Composition of the emulsifiable concentrate:

| | |
|---|---|
| Hexadecane | 81.8% |
| Synperonic ® L7 | 11.4% |
| Dodecanol | 2.3% |
| P2 (dry weight) | 0.7% |
| Water | q.s. for 100% |

The copolymer is introduced from a 16% aqueous solution.

The emulsion prepared according to the protocol described in example 3 in this case exhibits the following characteristics:
d₅₀=0.50 μm
76% by volume of the droplets exhibit a size of less than 1 μm.

### Examples 6-10

### Stability

Composition of the emulsifiable concentrates:

| | Example | | | | |
|---|---|---|---|---|---|
| | 6 | 7 | 8 | | |
| | comparative | comparative | comparative | 9 | 10 |
| Geronol | 1.2% | 1.6% | 2% | 1.14% | 1.52% |
| FF4* | | | | | |
| Geronol | 1.8% | 2.4% | 3% | 1.71% | 2.28% |
| FF6* | | | | | |
| P3** | 0% | 0% | 0% | 0.15% | 0.2% |
| Xylene | q.s. for | q.s. for | q.s. for | q.s. for | q.s. for |
| | 100% | 100% | 100% | 100% | 100% |

*Geronol FF4 and FF6: products sold by Rhodia, mixtures of ethoxylated tristyryiphenol and of calcium dodecylbenzenesulfonate in isobutanol
**P3 is a polystyrene-poly (acrylic acid) diblock copolymer with a weight-average molar mass of 3800-1200 g/mol (p(St)₃₈₀₀-b-p(AA)₁₂₀₀).

The emulsifiable concentrates are prepared at 20° C. by mixing, in a flask with stirring, the required amounts of xylene (Prolabo), Geronol FF4 and FF6, and the polymer P3. The copolymer P3 is introduced in the dry form. The emulsification is carried out by introducing 9.5 ml of municipal water and then 0.5 ml of emulsifiable concentrate into a measuring cylinder and by subsequently carrying out 20 inversions.

The change in the emulsions on storage at 30° C. is monitored by measuring the creaming and the coalescence (coal.). The creaming and the coalescence are expressed as % of the total volume of the emulsion.

| | Example | | | | |
|---|---|---|---|---|---|
| | | 7 | 8 | | |
| | 6 | compar- | compar- | | |
| | comparative | ative | ative | 9 | 10 |
| After 2 h | Creaming | Creaming | Creaming | No | No |
| | <2% | <2% | <2% | creaming | creaming |
| | No coal. | No coal. | No coal. | No coal. | No coal. |
| After 24 h | Coal. >1% | Coal. >1% | Coal. >1% | Creaming | Creaming |
| | | | | >2% | <2% |
| | | | | No coal. | No coal. |

1-24. (canceled)

25. A process for the preparation of a direct emulsion, wherein the dilution is carried out, in an aqueous phase, of a clear emulsifiable concentrate comprising an oil phase, optionally water, and amphiphilic compounds composed of at least one surfactant, at least one copolymer having at least one hydrophilic segment and at least one hydrophobic segment, with the exclusion of copolymers comprising only segments obtained from ethylene oxide and from propylene oxide, optionally at least one cosurfactant and optionally at least one neutralizing agent;
the total content of amphiphilic compounds representing 1 to 40% by weight of the emulsifiable concentrate;
the content of copolymer representing 0.1 to 25% by weight of said amphiphilic compounds;
more than 75% by volume of the droplets of the emulsion having a mean size of less than or equal to 1 μm;
the mean size of the droplets of an emulsion obtained by dilution of said concentrate being less than that of an emulsion obtained by dilution of an emulsifiable concentrate devoid of said copolymer, the total concentration of amphiphilic compounds being the same in both cases.

26. The process as claimed in claim 25, wherein the hydrophobic segment of the copolymer is obtained from one or more of the following monomers:
esters of linear, branched, cyclic or aromatic mono- or polycarboxylic acids comprising at least one ethylenic unsaturation,
α,β-ethylenically unsaturated nitrites, vinyl ethers, vinyl esters, vinylaromatic monomers, vinyl halides or vinylidene halides,
linear or branched aromatic or nonaromatic hydrocarbonaceous monomers comprising at least one ethylenic unsaturation,
propylene oxide or butylene oxide,
alone or as mixtures, and a macromonomer deriving from such monomers.

27. The process as claimed in claim 25, wherein the hydrophilic segment of the copolymer is obtained from one or more of the monomers comprising at least one carboxylic, sulfonic, sulfuric, phosphonic, phosphoric or sulfosuccinic functional group, their salts, and the corresponding macromonomers.

28. The process as claimed in claim 25, wherein the hydrophilic segment of the copolymer is obtained from one or more of the following monomers:
linear, branched, cyclic or aromatic mono- or polycarboxylic acids, the N-substituted derivatives of such acids, or monoesters of polycarboxylic acids comprising at least one ethylenic unsaturation;
linear, branched, cyclic or aromatic vinylcarboxylic acids;
amino acids comprising one or more ethylenic unsaturations;
alone or as mixtures, their precursors, their sulfonic or phosphonic homologs or their salts, and the macromonomers deriving from such monomers or from their salts.

29. The process as claimed in claim 25, wherein the hydrophilic segment of the copolymer is obtained from one or more of the following monomers:
aminoalkyl (meth)acrylates or aminoalkyl(meth)acrylamides;
monomers comprising at least one secondary, tertiary or quaternary amine functional group or a heterocyclic group comprising a nitrogen atom, vinylamine or ethyleneimine;
diallyldialkylammonium salts;
alone or as mixtures, or the corresponding salts, and the macromonomers deriving from such monomers.

30. The process as claimed in claim 25, wherein the hydrophilic segment of the copolymer is obtained from one or more of the following monomers:
ethylene oxide; the amides of linear, branched, cyclic or aromatic mono- or polycarboxylic acids comprising at least one ethylenic unsaturation, or derivatives; hydrophilic esters deriving from (meth)acrylic acid; vinyl esters which make it possible to obtain poly(vinyl alcohol) blocks after hydrolysis; vinylpyrrolidone; monomers of the type of the sugars, and the macromonomers deriving from such monomers.

31. The process as claimed in claim 25, wherein the hydrophobic segment can comprise one or more hydrophilic units.

32. The process as claimed in claim 25, wherein the hydrophilic segment can comprise one more hydrophobic units.

33. The process as claimed in claim 25, wherein the copolymer exhibits a weight-average molar mass of at most 50 000 g/mol.

34. The process as claimed in claim 33, wherein the copolymer exhibits a weight-average molar mass of at least 2500 g/mol.

35. The process as claimed in claim 25, wherein the copolymer exhibits a block structure, optionally a diblock or triblock structure.

36. The process as claimed in claim 25, wherein the copolymer exhibits a comb structure.

37. The process as claimed in claim 25, wherein the surfactant or surfactants are nonionic or anionic surfactants which are soluble in the oil.

38. The process as claimed in claim 25, wherein the surfactant or surfactants are nonionic surfactants selected from the group consisting of alkoxylated fatty alcohols; alkoxylated mono-, di- and triglycerides; alkoxylated fatty acids; alkoxylated sorbitan esters; alkoxylated fatty amines; alkoxylated alkylphenols; alkylpolyglucosides; polyoxyalkylenated surfactants; and alkoxylated mono- and dialkanolamides.

39. The process as claimed in claim 37, wherein the surfactant or surfactants are anionic surfactants, in acid form or combined with a polyvalent counterion and selected from the group consisting of alkyl ester sulfonates or alkyl ester sulfates; alkylbenzenesulfonates, alkylsulfonates; alkylglycerolsulfonates; alkyl sulfates; alkyl ether sulfates; alkylamide sulfates; salts of saturated or unsaturated fatty acids, N-acyl-N-alkyltaurates, alkyl isethionates, alkylsuccinamates; alkyl sulfosuccinates, monoesters of sulfosuccinates; diesters of sulfosuccinates, N-acylsarcosinates; polyethoxycarboxylates; alkyl phosphate esters; alkyl ether ether phosphate esters and alkylaryl ether phosphate esters.

40. The process as claimed in claim 25, wherein the copolymer with respect to the surfactant has a proportion by weight of between 0.5 and 10% by weight.

41. The process as claimed in claim 25, wherein the cosurfactant is a primary alcohol comprising at least one saturated or unsaturated and linear or branched aliphatic radical comprising from 4 to 22 carbon atoms or at least one aromatic radical, optionally carrying one or more alkyl substituents comprising 1 to 10 carbon atoms.

42. The process as claimed in claim 25, wherein the cosurfactant with respect to the surfactant has a cosurfactant/surfactant proportion by weight of between 0 (not included) and 50% by weight.

43. The process as claimed in claim 25, wherein the neutralizing agent is a compounds soluble in the oil phase and carrying at least one amine or carboxylic functional group.

44. The process as claimed in claim 25, wherein the neutralizing agent with respect to the surfactant has a neutralizing agent/surfactant proportion by weight of between 0 (not included) and 50% by weight.

45. The process as claimed in claim 25, having a total content of amphiphilic product of between 5 and 30% by weight of the emulsifiable concentrate.

46. The process as claimed in claim 25, having an amount of water such that the emulsifiable concentrate is clear, and of less than or equal to 10% by weight.

47. The process as claimed in claim 25, having a content of emulsifiable concentrate representing 0.1 to 40% by weight of the aqueous phase.

48. A clear emulsifiable concentrate comprising an oil phase, optionally water, and amphiphilic compounds composed of at least one surfactant, at least one copolymer having at least one hydrophilic segment and at least one hydrophobic segment, with the exclusion of copolymers comprising only segments obtained from ethylene oxide and from propylene oxide, optionally at least one cosurfactant and optionally at least one neutralizing agent; said concentrate having a total content of amphiphilic compounds representing 1 to 40% by weight of the emulsifiable concentrate and a content of copolymer representing 0.1 to 25% by weight of said amphiphilic compounds.
